(19) United States
(12) Patent Application Publication
(10) Pub. No.: US 2024/0428183 A1
(43) Pub. Date: Dec. 26, 2024

(54) METHODS AND SYSTEMS FOR DELIVERING AN ITEM TO A USER

(71) Applicant: Direct Cursus Technology L.L.C, Dubai (AE)

(72) Inventor: Alexei LAVRENIUK, Moscow (RU)

(21) Appl. No.: 18/737,416

(22) Filed: Jun. 7, 2024

(30) Foreign Application Priority Data
Jun. 21, 2023 (RU) 2023116353

(51) Int. Cl. G06Q 10/0836; B60P 3/00; G06K 19/06

(52) U.S. Cl. CPC G06Q 10/0836; B60P 3/007; G06K 19/06037

(57) ABSTRACT

There is disclosed a method of delivering an item to a user, the item to be delivered by one of a fleet of robotic vehicles. The method includes transmitting, by a server to an item provider, new order data indicative of (i) the item to be delivered and (ii) a target QR code representative of a target order ID, acquiring a request for order confirmation from a given robotic vehicle, the request for order confirmation including an in-use order ID. In response to the in-use order ID matching the target order ID, the given robotic vehicle is triggered from the fleet to receive the item, the server transmits the destination information to the given robotic vehicle for delivering the item and triggers operation of the given robotic vehicle based on the transmitted destination information.

### CROSS-REFERENCE

The present application claims priority to Russian Patent Application No. 2023116353, entitled “Methods and Systems for Delivering an Item to a User”, filed Jun. 21, 2023, the entirety of which is incorporated herein by reference.

### FIELD OF TECHNOLOGY

The present technology relates to methods and systems for delivering an item to a user, and more specifically, to a method of assigning a robotic vehicle from a fleet of robotic vehicle to a delivery task using a QR-code.

### BACKGROUND

Autonomous robotic vehicles are vehicles that are able to autonomously navigate through private and/or public spaces. Using a system of sensors that detects the location and/or surroundings of the robotic vehicle, logic within or associated with the robotic vehicle controls the velocity and direction of the robotic vehicle based on the sensor-detected location and surroundings of the robotic vehicle.

A variety of sensor systems may be used by the robotic vehicle, such as but not limited to camera systems, radar systems, and LIDAR systems. Different sensor systems may be employed for capturing different information, and/or in different format, about the location and the surroundings of the robotic vehicle. For example, LIDAR systems may be used to capture point cloud data for building 3D map representations of the surroundings and other potential objects located in proximity to the robotic vehicle.

Such autonomous robotic vehicles are being used for a wide variety of applications, including delivering packages and other items. To do so, an item provider may book a robotic vehicle from a fleet of robotic vehicles and wait until the selected robotic vehicle reach the item provider to receive the items. The robotic vehicle may further proceed with the delivery. However, it may be desirable to ameliorate a process of transferring the ordered item from the item provider to the robotic vehicle. Indeed, the above process does not allow the item provider to choose a specific robotic vehicle of his choice and rely entirely on the booking process.

US Patent application no. 2020/019925 discloses a method and a system for pickup and delivery of parcels, the system including a fleet of lockbox-equipped vehicles and a fleet of drones coordinated by back-end logistics software and a corresponding application which runs on user's mobile devices.

### SUMMARY

The developers of the present technology have developed a method for delivering an item from a provider, or “item provider”, to a user by a robotic vehicle operating in a fleet of robotic vehicles.

The developers have devised a method in which the robotic vehicles are communicably connected to a server, the server receiving an order from a user device associated with a user and transmitting order data to the item provider. The order data comprises indication of the item to be delivered and a target QR code representative of a target order ID. Information about the user are thus not provided to the item provider. More specifically, the server locally stores destination information (e.g. a delivery address associated with the user) for delivering the item and navigation information (e.g. a route between a current location of the selected robotic vehicle and the address of the user), thereby assuring a greater privacy of said information.

When the provider has prepared the item to be delivered, the provider may present an in-use QR code to any robotic vehicle of the fleet. As such, the present technology provides, to the item provider, freedom to choose any robotic vehicle of the fleet for the delivery. In response to reading the in-use QR code, the robotic vehicle transmits an in-use order ID extracted from the in-use QR code to the server. In the context of the present disclosure, an item provider is a computer-implemented entity (e.g. a server) that may be associated with any human or non-human entity suitable for storing, distributing and/or providing any physical item such as parcels, hardware components, mechanical equipment, etc. For example and without limitation, an item provider may be an electronic device that can access, store and/or handle information about a warehouse, a factory, a shop or any other entity suitable for providing items. An operator of the item provider may be a human entity that operates the item provider.

The server may then determine whether the in-use order ID matches the target order ID. In response to the in-use order ID matching the target order ID, the server causes the selected robotic vehicle to perform the delivery. More specifically, the server may trigger the robotic vehicle to receive the item, transmit the destination and/or navigation information of the current order to the robotic vehicle, and trigger operation of the robotic vehicle based on said information.

Developers of the present technology have realized that transmitting the destination and/or navigation information once matching of the in-use and target order IDs is detected provides greater privacy to the user. In some embodiments, order ID and user information may not need to be transferred to the item provider. Moreover, developers of the present technology have realized that enabling the item provider to choose any robotic vehicle for the delivery facilitates a streamlining of the process of transferring the ordered item from the item provider to any robotic vehicle, and ease logistic operations of the item provider.

In a first broad aspect of the present technology, there is provided a method of delivering an item to a user, the item to be delivered by one of a fleet of robotic vehicles, the fleet of robotic vehicles being communicatively coupled with a server. The method comprises transmitting, by the server to an item provider, new order data indicative of (i) the item to be delivered and (ii) a target QR code representative of a target order ID. The server locally stores destination information for delivering the item. The method further comprises acquiring, by the server, a request for order confirmation from a given robotic vehicle from the fleet, the request for order confirmation comprising an in-use order ID having been extracted by the given robotic vehicle from an in-use QR code presented to a camera sensor of the given robotic vehicle. The method further comprises, in response to the in-use order ID matching the target order ID, triggering, by the server, the given robotic vehicle from the fleet to receive the item, transmitting, by the server to the given robotic vehicle, the destination information for delivering the item and triggering, by the server, operation of the given robotic vehicle based on the transmitted destination information.

In some embodiments of the method, the item is selected from a group of items, said group comprising: edible items, drinkable items and non-consumable items.

In some embodiments of the method, the method further comprises, prior to transmitting the new order data, receiving, by the server and from a user device associated with the user, information about the item to be delivered.

In some embodiments of the method, the method further comprises, upon receiving information about the item to be delivered, generating a target QR code based on information associated with the user.

In some embodiments of the method, the server is communicably connected to a database, the database being configured to store said information about the user.

In some embodiments of the method, said information about the user comprises the destination information associated with the user for delivering the item.

In some embodiments of the method, the robotic vehicle comprises a lid operable between an opened position and a closed position, and triggering, by the server, the given robotic vehicle from the fleet to receive the item comprises causing, by the server, the lid to be actuated from the closed position to the opened position.

In some embodiments of the method, triggering, by the server, the given robotic vehicle from the fleet to receive the item further comprises causing, by the server, the lid to be actuated from the opened position to the closed position once the item has been received by the robotic vehicle.

In some embodiments of the method, the target order ID is associated with a target item weight, information about the target weight being locally stored by the server, and causing the lid to be actuated from the opened position to the closed position once the item has been received by the robotic vehicle is made in response to receiving, by the server, an in-use item weight, measured by the robotic vehicle, of the item received by the robotic vehicle and determining, by the server, that the in-use item weight is in a pre-determined range weight centered at target item weight.

In some embodiments of the method, the method further comprises, in response to the in-use order ID matching the target order ID, generating, by the server, a navigation information based on a current location of the given robotic vehicle and the destination information, the navigation information comprising indications of an itinerary to be followed by the robotic vehicle.

In some embodiments of the method, the method further comprises transmitting, by the server to the given robotic vehicle, the navigation information.

In some embodiments of the method, triggering, by the server, operation of the given robotic vehicle based on the transmitted destination information comprises triggering operation of the given robotic vehicle based on indications comprised in the navigation information.

In some embodiments of the method, acquiring, by the server, a request for order confirmation from a given robotic vehicle from the fleet comprises selecting the given robotic vehicle by an operator of the item provider.

In a second broad aspect of the present technology, there is provided a robotic vehicle for delivering an item from an item provider to a user, the robotic vehicle being communicably coupled to a server, the robotic vehicle comprising a body defining an interior space, a lid operable to access the interior space, a camera sensor disposed on an external side of the body, and a processor configured to control operation of the robotic vehicle. The processor is configured to transmit, to the server, a request for order confirmation, the request for order confirmation comprising an in-use order ID having been extracted by the robotic vehicle from an in-use QR code presented to the camera sensor, receive, from the server and in response to the in-use order ID matching a target order ID, instructions which, upon being executed by the processor, cause the lid to open such that the interior space receives the item, receive, from the server, a destination information for delivering the item and cause the robotic vehicle to navigate based on the destination information.

In some embodiments of the robotic vehicle, the lid is operable between an opened position and a closed position.

In some embodiments of the robotic vehicle, the processor is further configured to cause the lid to be actuated from the opened position to the closed position once the item has been received in the interior storage space.

In some embodiments of the robotic vehicle, the robotic vehicle further comprises a weighting device communicably connected to the processor and configured to determine an in-use item weight of the item received in the interior space storage.

In some embodiments of the robotic vehicle, the processor is further configured to transmit information received from the weighting device to the server, and, in response to the server determining that the in-use item weight is in a weight range centered at a target item weight, receive, from the server, instructions which upon being executed by the processor cause the lid to close.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for use in some implementations of systems and/or methods of the present technology.

FIG. 2 depicts an electronic device of a robotic vehicle communicatively coupled to a server in accordance with some embodiments of the present technology.

FIG. 3 there is depicted a representation of the robotic vehicle with a lid in an opened position and a representation of the robotic vehicle with the lid in a closed position.

FIG. 4 is a schematic diagram of electronic components that can be used for operating the robotic vehicle.

FIG. 5 is a schematic diagram of a communication between the robotic vehicle of FIGS. 2 and 3 and a server in response to the robotic vehicle scanning a QR-code.

FIG. 6 is a schematic diagram of data accessible by the server of FIG. 5.

FIG. 7 shows a flowchart of a method performed in accordance with various implementations of the disclosed technology.

### DETAILED DESCRIPTION

Various representative implementations of the disclosed technology will be described more fully hereinafter with reference to the accompanying drawings. The present technology may, however, be implemented in many different forms and should not be construed as limited to the representative implementations set forth herein. In the drawings, the sizes and relative sizes of layers and regions may be exaggerated for clarity. Like numerals refer to like elements throughout.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

It will be understood that, although the terms first, second, third, etc. may be used herein to describe various elements, these elements should not be limited by these terms. These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The functions of the various elements shown in the figures, including any functional block labeled as a “processor,” may be provided through the use of dedicated hardware as well as hardware capable of executing software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, an application-specific integrated circuit (ASIC), a field-programmable gate array (FPGA), a read-only memory (ROM) for storing software, a random-access memory (RAM), and non-volatile storage. Other hardware, conventional and/or custom, may also be included.

Software modules, or simply modules or units which are implied to be software, may be represented herein as any combination of flowchart elements or other elements indicating the performance of process steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

At least some aspects of the present technology may be implemented as a system, a method, and/or a computer program product. The computer program product may include a computer-readable storage medium (or media) storing computer-readable program instructions that, when executed by a processor, cause the processor to carry out aspects of the disclosed technology. The computer-readable storage medium may be, for example, an electronic storage device, a magnetic storage device, an optical storage device, an electromagnetic storage device, a semiconductor storage device, or any suitable combination of these. A non-exhaustive list of more specific examples of the computer-readable storage medium includes: a portable computer disk, a hard disk, a random-access memory (RAM), a read-only memory (ROM), a flash memory, an optical disk, a memory stick, a floppy disk, a mechanically or visually encoded medium (e.g., a punch card or bar code), and/or any combination of these. A computer-readable storage medium, as used herein, is to be construed as being a non-transitory computer-readable medium. It is not to be construed as being a transitory signal, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that computer-readable program instructions can be downloaded to respective computing or processing devices from a computer-readable storage medium or to an external computer or external storage device via a network, for example, the Internet, a local area network, a wide area network and/or a wireless network. A network interface in a computing/processing device may receive computer-readable program instructions via the network and forward the computer-readable program instructions for storage in a computer-readable storage medium within the respective computing or processing device.

Computer-readable program instructions for carrying out operations of the present disclosure may be assembler instructions, machine instructions, firmware instructions, configuration data for integrated circuitry, or either source code or object code written in any combination of one or more programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network.

All statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable program instructions. These computer-readable program instructions may be provided to a processor or other programmable data processing apparatus to generate a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowcharts, flow diagrams, state transition diagrams, pseudo-code, and the like.

The computer-readable program instructions may also be loaded onto a computer, other programmable data processing apparatus or other devices to cause a series of operational steps to be performed on the computer, other programmable apparatus or other devices to generate a computer-implemented process, such that the instructions which execute on the computer, other programmable apparatus, or other device implement the functions/acts specified in the flowcharts, flow diagrams, state transition diagrams, pseudo-code, and the like.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures, and combinations of such functions can be implemented by special-purpose hardware-based systems that perform the specified functions or acts or by combinations of special-purpose hardware and computer instructions.

With these fundamentals in place, we will now consider some non-limiting examples to illustrate various implementations of aspects of the present disclosure.

### Computer System

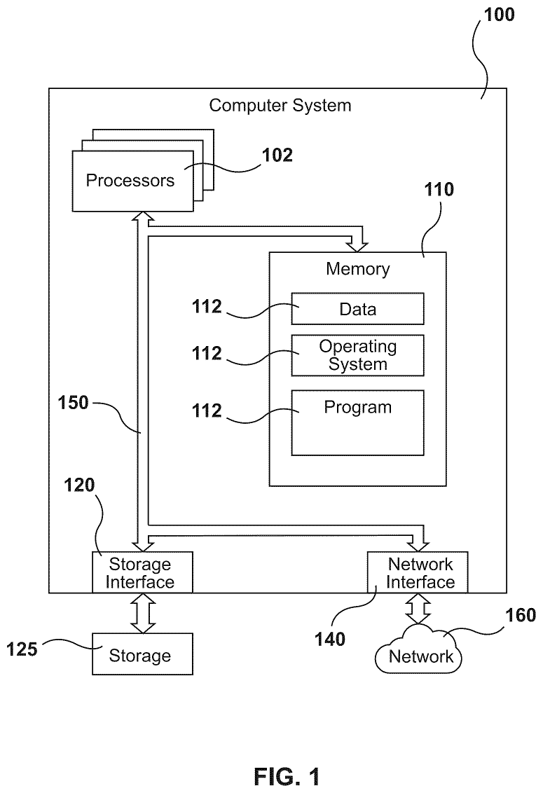

FIG. 1 depicts a computer system 100 implemented in accordance with a non-limiting embodiment of the present technology. The computer system 100 may be a laptop computer, a tablet computer, a smartphone, an embedded control system, or any other computer system currently known or later developed. Additionally, it will be recognized that some or all the components of the computer system 100 may be virtualized and/or cloud-based. As shown in FIG. 1, the computer system 100 includes one or more processors 102, a memory 110, a storage interface 120, and a network interface 140. These system components are interconnected via a bus 150, which may include one or more internal and/or external buses (not shown) (e.g. a PCI bus, universal serial bus, IEEE 1394 “Firewire” bus, SCSI bus, Serial-ATA bus, etc.), to which the various hardware components are electronically coupled.

The memory 110, which may be a random-access memory or any other type of memory, may contain data 112, an operating system 114, and a program 116. The data 112 may be any data that serves as input to or output from any program in the computer system 100. The operating system 114 may be an operating system such as Microsoft Windows™ or Linux™. The program 116 may be any program or set of programs that include programmed instructions that may be executed by the processor to control actions taken by the computer system 100.

The storage interface 120 is used to connect storage devices, such as the storage device 125, to the computer system 100. One type of storage device 125 is a solid-state drive, which may use an integrated circuit assembly to store data persistently. A different kind of storage device 125 is a hard drive, such as an electro-mechanical device that uses magnetic storage to store and retrieve digital data. Similarly, the storage device 125 may be an optical drive, a card reader that receives a removable memory card, such as an SD card, or a flash memory device that may be connected to the computer system 100 through, e.g., a universal serial bus (USB).

In some implementations, the computer system 100 may use well-known virtual memory techniques that allow the programs of the computer system 100 to behave as if they have access to a large, contiguous address space instead of access to multiple, smaller storage spaces, such as the memory 110 and the storage device 125. Therefore, while the data 112, the operating system 114, and the programs 116 are shown to reside in the memory 110, those skilled in the art will recognize that these items are not necessarily wholly contained in the memory 110 at the same time.

The processors 102 may include one or more microprocessors and/or other integrated circuits. The processors 102 execute program instructions stored in the memory 110. When the computer system 100 starts up, the processors 102 may initially execute a boot routine and/or the program instructions that make up the operating system 114.

The network interface 140 is used to connect the computer system 100 to other computer systems or networked devices (not shown) via a network 160. The network interface 140 may include a combination of hardware and software that allows communicating on the network 160. In some implementations, the network interface 140 may be a wireless network interface. The software in the network interface 140 may include software that uses one or more network protocols to communicate over the network 160. For example, the network protocols may include TCP/IP (Transmission Control Protocol/Internet Protocol).

It will be understood that the computer system 100 is merely an example and that the disclosed technology may be used with computer systems or other computing devices having different configurations.

### Robotic Vehicle

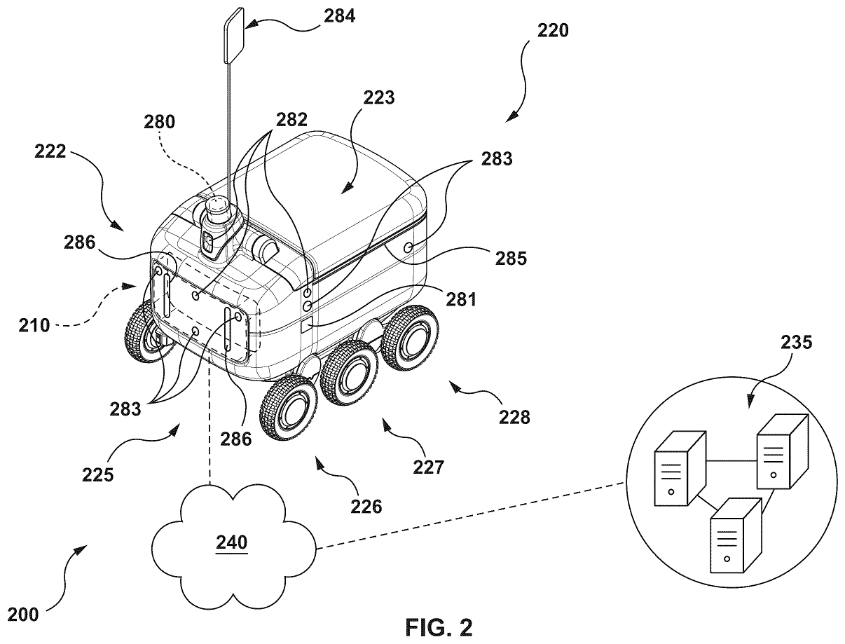

FIG. 2 depicts a networked environment 200 suitable for use with some non-limiting implementations of the present technology. The environment 200 includes a computing device 210 associated with a robotic vehicle 220. The environment 200 also includes one or more servers 235 in communication with the computing device 210 via a communication network 240 (e.g. the Internet or the like).

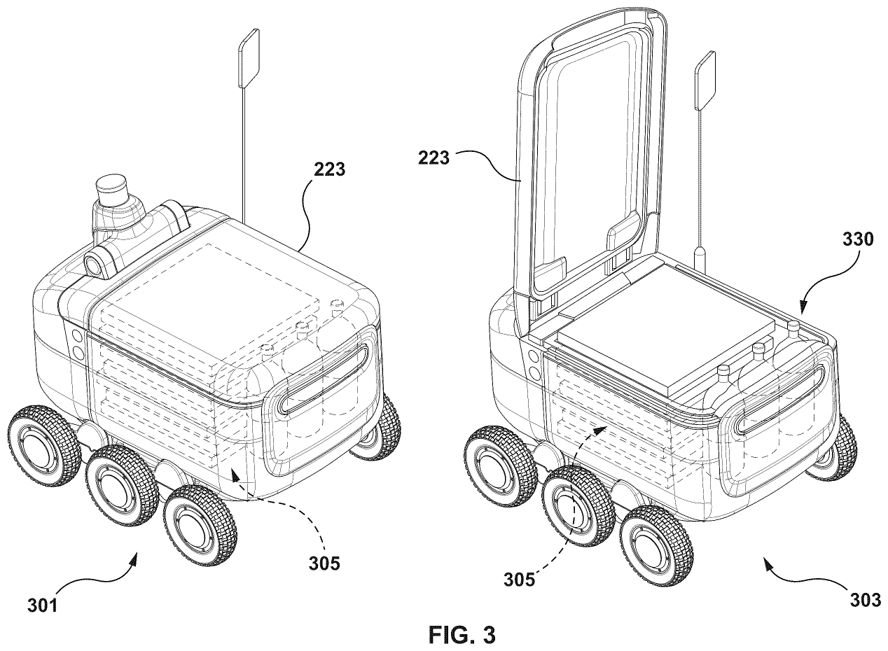

As can be seen the robotic vehicle 220 can comprise a body 222 and a lid 223. Other configurations for different applications are also possible. The robotic vehicle 220 shown can be particularly used for the transfer of deliveries (such as mail, groceries, parcels, packages, flowers, medical equipment and/or purchases). With a brief reference to FIG. 3, there is depicted a representation 301 of the robotic vehicle 220 with the lid 223 in an opened position and a representation 303 of the robotic vehicle 220 with the lid 223 in a closed position. When the lid 223 is in an opened position, access to an interior storage space 307 is provided for placing and/or removing items 305. The items 305 may be for example, edible items, drinkable items and/or non-consumable items. In some embodiments, a bottom of the interior storage space 307 is provided with a weighting device (e.g. a scale) for weighting the items 305 placed in the interior storage space 307. The weighting device may be communicably connected to the processors 102.

Returning to the description of FIG. 2, a chassis 225 is arranged at the bottom of the robotic vehicle 220. As can be seen in the embodiment shown three sets or pairs of wheels are provided—that is, wheels 226, wheels 227 and wheels 228. The robotic vehicle 220 also comprises illumination/signaling elements 284, 285 and 286 that are used for providing visual information to person(s) in the surroundings of the robotic vehicle 220. It is contemplated that a variety of systems and components of the robotic vehicle 220 may be attached to the chassis 225, such as, but not limited to: a suspension system, a battery, exterior panels, electronic components, and a body frame. In some implementations, the chassis 225 may be fabricated from aluminum. In other implementations, both the body 222 and the chassis 225 may be fabricated from a fiberglass material.

In one implementation, the robotic vehicle 220 may have a weight of 70 kg when empty. In another implementation, the robotic vehicle may operate at a top speed of 8 km/h. In a further implementation, the robotic vehicle 220 may have a ground clearance at full load of 100 mm.

The robotic vehicle 220 may be a fully autonomous vehicle that may, in use, travel independently from any human decision, or a partially autonomous vehicle, in which a human operator can selectively remotely control some aspects of the robotic vehicle's operation, while other aspects are automated or where the human operator controls the operations under certain conditions (such as when the robotic vehicle 220 is stuck and cannot determine in an autonomous regime how to move forward). As one non-limiting example, the robotic vehicle 220 may operate autonomously unless or until it encounters an unexpected or unusual situation that it is unable to handle autonomously, at which time a remote human operator could be contacted. It should be noted that specific parameters of the robotic vehicle 220 are not limiting, these specific parameters including for example: manufacturer, model, year of manufacture, vehicle weight, vehicle dimensions, vehicle weight distribution, vehicle surface area, vehicle height, motor type, tire type (if tires are used), power system, or other characteristics or parameters of a vehicle. The robotic vehicle 220, to which the computing device 210 is associated, could be any robotic vehicle, for delivery applications, warehouse applications, or the like.

In at least some non-limiting implementations of the present technology, the computing device 210 is communicatively coupled to control systems of the robotic vehicle 220. The computing device 210 could be arranged and configured to control different operation systems of the robotic vehicle 220, including but not limited to: motor control, steering systems, and signaling and illumination systems.

In some non-limiting implementations of the present technology, the networked computing environment 200 could include a GPS satellite (not depicted) transmitting and/or receiving a GPS signal to/from the computing device 210. It will be understood that the present technology is not limited to GPS and may employ a positioning technology other than GPS. It should be noted that the GPS satellite can be omitted altogether.

According to the non-limiting embodiments of the present technology, the implementation of the computing device 210 is not particularly limited. For example, the computing device 210 could be implemented as a vehicle motor control unit, a vehicle CPU, a computer system built into the robotic vehicle 220, a plug-in control module, and the like. Thus, it should be noted that the computing device 210 may or may not be permanently associated with the robotic vehicle 220.

The computing device 210 can include some or all of the components of the computer system 100 depicted in FIG. 1, depending on the particular implementation of the present technology. In certain implementations, the computing device 210 is an on-board computer device and includes the processors 102, the storage device 125 and the memory 110. In other words, the computing device 210 includes hardware and/or software and/or firmware, or a combination thereof, for processing data and performing a variety of actions in response to the processed data. For example, the computing device 210 may receive data from one or more sensors and/or the server 235, process the received data, and trigger movement of the robotic vehicle 220 based on the processed data.

In some non-limiting implementations of the present technology, the communication network 240 is the Internet. In alternative non-limiting implementations of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the computing device 210 and the communication network 240, the implementation of which will depend, inter alia, on how the computing device 210 is implemented. Merely as an example and not as a limitation, the communication link can be implemented as a wireless communication link. Examples of wireless communication links may include, but are not limited to, a 3G communication network link, a 4G communication network link, and the like. The communication network 240 may also use a wireless connection with the servers 235.

In some implementations of the present technology, the servers 235 can be implemented as computer servers and could include some or all of the components of the computer system 100 of FIG. 1. In one non-limiting example, the servers 235 are implemented as a Dell™ PowerEdge™ Servers running the Microsoft™ Windows Server™ operating system but can also be implemented in any other suitable hardware, software, and/or firmware, or a combination thereof.

In some non-limiting implementations of the present technology, the processors 102 of the computing device 210 could be in communication with the servers 235 to receive one or more updates. Such updates could include, but are not limited to, software updates, map updates, route updates, geofencing updates, weather updates, and the like. In some non-limiting implementations of the present technology, the computing device 210 can also be configured to transmit to the servers 235 certain operational data, such as routes traveled, traffic data, performance data, and the like. Some or all such data transmitted between the robotic vehicle 220 and the servers 235 may be encrypted and/or anonymized.

It should be noted that a variety of sensors and systems may be used by the computing device 210 for gathering information about surroundings of the robotic vehicle 220. The robotic vehicle 220 is equipped with a plurality of sensors (not numbered). It should be noted that different sensor systems may be used for gathering different types of data regarding the surroundings of the robotic vehicle 220. It is contemplated that a plurality of different sensor systems may be used in combination by the robotic vehicle 220, without departing from the scope of the present technology.

In the non-limiting example illustrated in FIG. 2, the robotic vehicle 220 includes a LIDAR system 280 that mounted to the robotic vehicle 220 and communicatively coupled to the computing device 210. Broadly speaking, a LIDAR system is configured to capture data about the surroundings of the robotic vehicle 220 used, for example, for building a multi-dimensional map of objects in the surroundings of the robotic vehicle 220. More specifically, the LIDAR system 280 may determine location and distance of objects based reflection of transmitted light energy using pulsed laser light. Upon hitting an object with a transmitted lased pulse, the pulse is reflected back to a sensor of the LIDAR system 280. The object distance may then be calculated by measuring the pulse travel time. Typical LIDAR systems may generate rapid pulses of laser light at rates of up to several hundred thousand pulses per second. In most cases, the energy of automotive lidar beams is limited to eye-safe level of Class 1 laser product.

In at least some embodiments, the LIDAR system 280 comprises laser diodes to generate the laser beams, photodiodes to receive the returning (i.e. reflected) signals, and a servo-mounted mirror device to direct the laser beam horizontally and vertically. The generated laser pulses are guided through the mirror device actuated by a servo-motor. The mirror device may be adjusted to transmit pulses at different vertical and/or horizontal angles. An optical encoder provides feedback to the servo motor to enable precise control of the mirror and the resulting laser transmission. The returning signals are captured by the photodiodes and processed by a signal processing unit of the LIDAR system 280. The LIDAR system 280 may generate a series of point cloud data representative of the detected objects, with associated information about the measured distance and location in 3D coordinates relative to the LIDAR system 280.

In one embodiment, the LIDAR system 280 can be implemented as a rotational LIDAR system emitting sixty-four (64) light beams, however other configurations are envisioned without departing from the scope of the present technology. For example, one or more LIDAR systems could be mounted to the robotic vehicle 220 in a variety of locations and/or in a variety of configurations for gathering information about surroundings of the robotic vehicle 220.

As alluded to above, the computing device 210 can be configured to detect one or more objects in the surroundings of the robotic vehicle 220 based on data acquired from one or more camera systems and from one or more LIDAR systems. For example, the computing device 210 configured to detect a given object in the surroundings of the robotic vehicle 220 may be configured to identify LIDAR data and camera data associated with the given object, generate an “embedding” representative of features associated with the given object, and detect the object by generating a bounding box for the object.

In the non-limiting example illustrated in FIG. 2, the robotic vehicle 220 includes radar systems 281 that are mounted to the robotic vehicle 220 and communicatively coupled to the computing device 210. Broadly speaking, the one or more radar systems may be configured to make use of radio waves to gather data about various portions of the surroundings of the robotic vehicle 220. For example, the one or more radar systems may be configured to gather radar data about potential objects in the surroundings of the robotic vehicle 220, such data potentially being representative of a distance of objects from the radar systems, orientation of objects, velocity and/or speed of objects, and the like.

More specifically, the radar systems 281 may employs radio waves, i.e. electromagnetic wavelengths longer than infrared light, to detect and track objects. Said radar systems 281 may emit pulses of radio waves that are reflected off objects surrounding the robotic vehicle 220, thereby causing returning waves providing information on the direction, distance and estimated size of each object in the surrounding of the robotic vehicle 220. The radar system 281 may also be used to determine a direction and speed of an object's movement by releasing multiple consecutive pulses. The radar system 281 may for example comprise two echo radar devices disposed in different positions on the robotic vehicle 220, such as to capture additional information on an object's position, such at an angle of the object. The radar system 281 may analyze wave phases (e.g. such as a Doopler radar) by keeping track of each particular wave and detecting differences in the position, shape, and form od the wave when it returns from the object to the radar system 281. The received information can further be used to determine whether the wave has undergone a positive or negative shift. A negative shift means that the object is most likely moving away from the radar system 281, while a positive shift indicates that the object is moving toward the radar system 281. A value of said shift may be used to determine the speed of the object.

In the non-limiting example illustrated in FIG. 2, the robotic vehicle 220 includes camera sensors 282 that are mounted to the robotic vehicle 220 and communicatively coupled to the computing device 210. Broadly speaking, the one or more camera sensors 282 may be configured to gather image data about various portions of the surroundings of the robotic vehicle 220. In some cases, the image data provided by the one or more camera sensors 282 could be used by the computing device 210 for performing object detection procedures. For example, the computing device 210 could be configured to feed the image data provided by the one or more camera sensors 282 to an Object Detection Neural Network (ODNN) that has been trained to localize and classify potential objects in the surroundings of the robotic vehicle 220.

In some embodiments, one or more camera sensors may be equipped with fisheye lenses with a viewing angle of more than 180 degrees. It is contemplated that one or more camera sensors may be located on the robotic vehicle 220 and oriented in a manner that at least a portion of the robotic vehicle 220 is visible by the one or more camera sensors. In further embodiments, one or more camera sensors may be equipped with long-focus lenses. For example, a front-facing camera sensor may be equipped with such a lens for better “seeing” traffic lights on an opposite side of a street to be crossed.

In this embodiment, one camera sensor 282 may scan a quick response code (QR code). A QR-code is a machine-readable optical label that may contain, or refer to, information about an item to which it is attached for example. In other words, a QR code is matrix-style barcode used as an optical label. In practice, QR codes often contain information for a locator, identifier, or tracker that points to a website or an application. As such, the computing device 210 may receive optical information from the camera sensor 282 and communicate with the one or more servers 235 via the communication network 240 to access a content to which the QR code refers.

In the non-limiting example illustrated in FIG. 2, the robotic vehicle 220 includes ultrasonic sensors 283 that are mounted to the robotic vehicle 220 and communicatively coupled to the computing device 210. Broadly speaking, an ultrasonic sensor is an instrument that measures the distance to an object using ultrasonic sound waves. Such sensors may include uses a transceiver to send and receive ultrasonic pulses that relay back information about an object's proximity. Sound waves produced by one or more ultrasonic sensors may reflect from boundaries to produce distinct echo patterns. In some embodiments, one or more ultrasonic sensors of the robotic vehicle 220 may provide an indication of a distance of a given object, and an echogram. It is contemplated that such information may be leveraged for adjusting action triggering thresholds depending on inter alia different weather conditions and road surfaces.

More specifically, ultrasonic sensors 283 may use these high frequency acoustic waves for object detection and ranging. In use, the ultrasonic sensors 283 transmit packets of waves and determine a travel time for said waves to be reflected on an object and return back to the ultrasonic sensors 283. In most cases, the acoustic waves used in ultrasonic sensors are non-audible to humans, because the waves are transmitted with high amplitude (>100 dB) for the sensors to receive clear reflected waves. In some implementations, the ultrasonic sensors 283 comprises a transmitter, which converts an electric alternating current (AC) voltage into ultrasound, and a receiver, which generates AC voltage when a force is applied to it.

In at least some embodiments, the robotic vehicle 220 further comprises an inertial measurement unit including motion sensors such as accelerometers (e.g. capacitive accelerometers, piezoelectric accelerometers, or any other suitable accelerometers), gyroscopes (e.g. mechanical gyroscopes, optical gyroscopes, Micro Electro-Mechanical System gyroscopes, or any other suitable gyroscopes) and magnetometers to determine a position and characteristics of movements of the robotic vehicle 220. For example, the inertial measurement unit may comprise three gyroscopes and three accelerometers providing six degree-of-freedom pose estimation capabilities. Additionally, the inertial measurement unit may comprise three magnetometers to provide a nine degree-of freedom estimation.

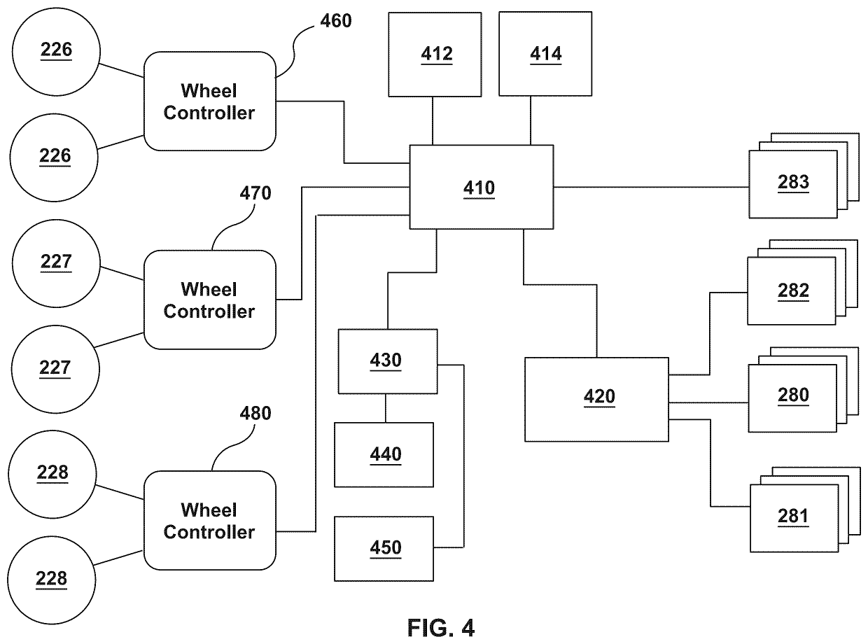

With reference to FIG. 4, there is depicted a schematic diagram 400 of electronic components that can be used for operating the robotic vehicle 220. It is contemplated that the computing device 210 may include one or more electronic components including: a main controller 420, a platform controller 410, a peripheral controller 430, and a plurality of wheel controllers 460, 470, 480. In some alternative non-limiting embodiments, functionality of some or all of the computing device 210, the main controller 420, the platform controller 410, the peripheral controller 430, and the plurality of wheel controllers 460, 470, 480 may be combined into one or more computing devices.

The wheel controllers may be implemented as dedicated processors. It is contemplated that one or more electronic components of the robotic vehicle 220 may be located inside a common and/or respective sealed enclosures. In some implementations, communication between various electronic components may be provided via Controller Area Network (CAN) buses. In his embodiment, and in addition to the CAN buses, some communications between the various electronic components, and notably between the main controller 420 and the computing device 210, is based on Ethernet communication protocol. It is also contemplated that some electronic components may be provided power at voltage battery (VBAT), while other electronic components may be provided power at 12 volts. Furthermore, transmission of information among the various electronic component involves signal converters for converting information received at one of the electronic components in a suitable format (e.g. digital signals, discrete signals and/or analog signals).

Broadly speaking, the main controller 420 is in a sense the “brain” of the robotic vehicle 220. The main controller 420 is a computer system configured to execute one or more computer-implemented algorithms for recognizing objects (such as people, cars, obstacles, for example), plan trajectory of movement of the robotic vehicle, localize the robotic vehicle 220 in its surroundings, and so forth. The main controller 420 may comprise a router through which other components can be connected to a single on-board network. In one implementation, video data from camera sensors 282, LIDAR data from the LIDAR system 280, and radar data from the radar systems 281 may be provided to the main controller 420.

Broadly speaking, the platform controller 410 is configured to power one or more electronic components of the robotic vehicle 220. For example, the platform controller 410 may be configured to control current limits on respective power branches, switch power to an auxiliary battery 414 when a main battery 412 is removed and/or is being replaced. It is also contemplated that the platform controller 410 may be configured to generate wheel control commands and collect data from the ultrasonic sensors 283. Alternatively, ultrasonic data may be collected by one or more other controllers inside the robotic vehicle 220 without departing from the scope of the present technology.

Broadly speaking, the peripheral controller 430 is configured to control one or more peripheral systems of the robotic vehicle 220. For example, the peripheral controller 430 may be configured to control a lid system 440 and a lighting system 450 of the robotic vehicle 220. More specifically, the lid system 404 comprises the lid 223 and a motor operatively connected to the lid 223. The lid system 440 may also comprise sensors to detect a position of the lid 223, a rotation speed of the motor of the lid 223, and/or any other information relative to actuation of the lid 223. As such, the peripheral controller 430 may for example control the motor of the lid 223 to lock and unlock the lid 223. The lighting system 450 comprises the illumination/signaling elements 284, 285 and 286 that are used for providing visual information to person(s) in the surroundings of the robotic vehicle 220. As such, the peripheral controller 430 may for example control visual signals provided by the one or more visual indications (e.g. illumination/signaling elements 284, 285 and 286) of the robotic vehicle 220.

Broadly speaking, the wheel controllers 460, 470 and 480 are configured to control operation of respective wheels of the robotic vehicle 220. In some embodiments, the robotic vehicle 220 may comprise motor-wheels (or “in-wheel motors”) for driving the wheels. More specifically, each motor-wheel operates a corresponding wheel and is implemented into a hub of the corresponding wheel to drive said wheel directly. The motor-wheels may be implemented in the robotic vehicle instead of a motor located inside the body 222. Implementation of the motor-wheels may provide more room in the body 222 and may reduce risk of over-heating other components inside the body 222 due to thermal energy expelled by the motor. For example, a given wheel controller may receive speed values for respective wheels from the platform controller 410 and may control currents in the windings of the motor-wheels, for example, so as to provide the desired speed in a variety of driving conditions.

### Robotic Vehicle Operation

At least some aspects of the present technology may provide navigation and/or motion planning for operating the robotic vehicle 220 in the surroundings and which includes both static and dynamic (i.e., moving) objects. The robotic vehicle 220 may navigate and move in urban and/or suburban settings for delivering goods, packages, boxes, and/or other parcels. The robotic vehicle 220 may navigate in outdoor environments (e.g. streets, crosswalks, field). Because of the tasks that it performs, the robotic vehicle 220 may be configured to travel along sidewalks and footways. Thus, the motion planning module in the robotic vehicle considers the behavior of pedestrians moving along or crossing its path. Additionally, the robotic vehicle 220 may cross roads. Cars and other vehicles moving on roads in urban and/or suburban settings may not notice small-sized robotic vehicles, for example, which may lead to collisions that could damage or destroy the robotic vehicle 220 and its cargo. Consequently, the motion planning module for the robotic vehicle 220 may consider objects in a roadway, including, e.g. moving and parked cars and other vehicles.

The robotic vehicle 220 may also navigate in indoor environments such as offices, warehouses, convention centers, or any other indoor environments where the robotic vehicle 220 is requested to navigate. Thus, the motion planning module in the robotic vehicle considers the behavior of human entities and non-human entities (e.g. animals) moving along or crossing its path.

For a delivery vehicle, one important goal may be to deliver a parcel from a starting point to a destination by a particular time. Thus, the motion planning module may consider the speed of the robotic vehicle 220 and determine that adequate progress is being made toward the destination. These considerations are particularly relevant when the delivery tasks are time-critical or when the destination is remote.

For purposes of illustration, the robotic vehicle 220 uses the LIDAR system 280. The computing device 210 associated with the robotic vehicle 220 receives data from the sensors and may generate a 3D map of points (point cloud). This 3D map of points may be used by the robotic vehicle to inter alia obtain a distance from surrounding objects and to determine a trajectory and speed.

It is contemplated that the robotic vehicle 220 may also make use of a 3D map representation that is provided thereto by the servers 235. For example, the 3D map representation of an environment in which the robotic vehicle 220 is to operate may be “built” on the servers 235 and may be accessible remotely by the robotic vehicle 220, without departing from the scope of the present technology. Additionally, or alternatively, the 3D map representation of the environment may also be transmitted, at least in part, to the robotic vehicle 220 for local storage and local access purposes.

It should be noted that the servers 235 may collect information from one or more robotic vehicles (e.g., a fleet) that are tasked with mapping the environment, thereby generating respective 3D map representations of a given region. For example, one or more robotic vehicles may generate a 3D map representation of a street, a block, a municipality, a city, and a like. This information may be collected by the servers 235 for unifying information from the one or more robotic vehicles into a 3D map representation to be used during operation of the robotic vehicle 220. It is contemplated that a 3D map representation used by the robotic vehicle 220 for navigation and motion planning may have a system of coordinates for locating various objects found in the environment such as poles, mailboxes, curbs, roads, buildings, fire hydrants, traffic cones, traffic lights, crosswalks, trees, fences, billboards, landmarks, and the like. As another example, the one or more robotic vehicles may generate a 3D map representation of an office, one or more floors of a building, a mall, a convention center, a warehouse, a datacenter or any other indoor environments suitable for navigation of the one or more robotic vehicles. It is contemplated that a 3D map representation used by the robotic vehicle 220 for navigation and motion planning may have a system of coordinates for locating various objects found in the environment such as furniture, doors, racks, stairs, staircases, shops, elevators, and the like.

### Delivery

The developers of the present technology have realized that some steps of a delivery of an item from an item provider to a user may experience delays due to an availability of robotic vehicles from a fleet and a number of prioritization algorithms that assign robotic vehicles to items for delivery. Therefore, it may be desirable to ameliorate a process of transferring the item from a corresponding item provider to a delivery robotic vehicle.

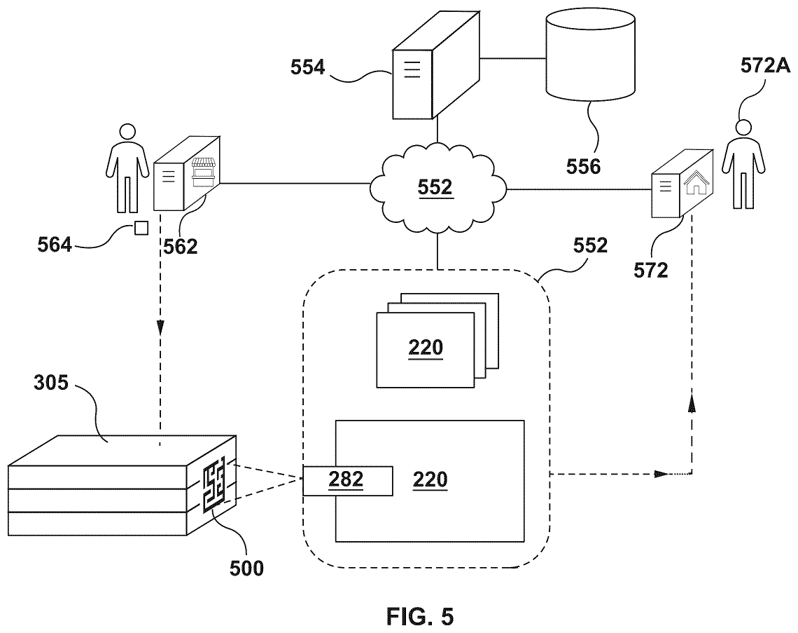

To better illustrate this, reference will now be made to FIG. 5 depicting the robotic vehicle 220 in communication with a server 554 for a delivery of the item 305 from an item provider 562 to a user device 572 associated with a corresponding user 572A. The user device 572 may be any electronic device, such as a smartphone, suitable for the task recited herein. For example and without limitation, the user device 572 and/or the item provider 562 may be implemented as the computer device 100. In the context of the present disclosure, a user device is a computer-implemented entity (e.g. a smartphone) that may be associated with any human or non-human entity suitable for receiving any physical item such as parcels, hardware components, mechanical equipment, etc. For example and without limitation, a user device may be an electronic device that can access communicate with the server 554. A user of the user device may be any operator of the user device.

In this embodiment, the item provider 562, the user device 572, and the robotic vehicle 220 are communicably connected to the server 554 via a communication network 552 (e.g. the Internet). The server 554 may be one of the servers 235 or may have similar characteristics.

As an example, the user 572A may have placed an order to the item provider 562 (e.g. an online order executed on the Internet) through the user device 572. As a result, the item provider 562 receives an order data 564 indicative of the item 305 to be delivered and a target QR code representative of a target order identification (or “target order ID”). In other words, the target order ID may serve as an identifier of the order placed by the user 572A. The server 554 may generate the target QR code upon detecting that the user device 572 has placed the order.

It should be noted that the server 554 locally stores a destination and/or navigation information for delivering the item. Said destination information may be, for example, an address of the user 572A. In some embodiments, the navigation information may be indicative of an itinerary to be followed by the robotic vehicle 220 to reach a destination, as indicated in the destination information, from a current position of the robotic vehicle. Generation of the navigation information is described in greater details herein further below. As such, the destination information and the navigation information relative to the user 572A may not be accessible by the item provider 562, thereby assuring a greater privacy of said information and of information about the user-576A. The server 554 may be for example communicably connected to a database 556 that may store said information. The database 556 may be any hardware device connected to the server 554 (e.g. a local storage device thereof). The database 556 may be for example communicably connected to the server 554 via a dedicated communication network that may be private or public.

As depicted on FIG. 5, a fleet 550 of a plurality of robotic vehicles 220 may be available to the item provider 562 for sending the item 305. As such, the item provider 562 may choose any one of the robotic vehicles 220 to perform the delivery. The selected robotic vehicle 220 may be for example a closest one robotic vehicle 220 of the fleet 550 or the only one near the item provider 562.

Once the item provider 562 has selected the robotic vehicle 220, the item provider 562 may present an in-use QR code 500 to the robotic vehicle 220. The in-use QR code may be, for example and without limitation, provided on a packaging of the item 305 or a receipt of the order. It should be understood that a given in-use or target QR code may be associated with a plurality of items of a same order.

As previously described, the camera sensor 282 of the selected robotic vehicle 220 may be employed by the computing device 210 for capturing the in-use QR code 500. The computing device 210 may transmit a request for identifying a current order, or “order confirmation request”, to the server 554 based on the in-use QR code 500. Broadly speaking, the in-use QR code is matrix-style barcode used as an optical label and contains information about an in-use order ID. Said information is extracted by the computing device 210 and further transmitted to the server 554 when transmitting the request for identifying the current order.

The server 554 may be configured to compare the in-use order ID against one or more current order IDs stored in the system. For example, the server 554 may compare the in-use order ID against one or more order IDs of current delivery requests (e.g., active ones). If determination is made by the server 554 that the in-use order ID matches the target order ID, the server 554 may cause the robotic vehicle 220 to perform the delivery. For example, the server 554 may transmit destination and/or navigation information to the robotic vehicle 220. In one embodiment, if determination is made by the server 554 that the in-use order ID does not match the target order ID, the server 554 may cause the robotic vehicle 220 to emit a luminous and/or audio signal to the item provider 562 to indicate an erroneous in-use QR code 500.

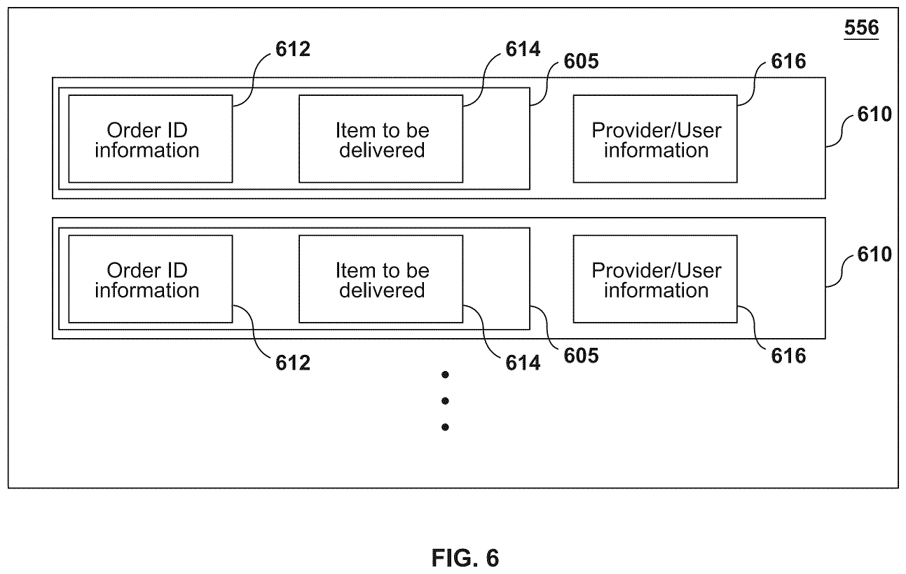

FIG. 6 is a schematic diagram of data accessible by the server 554 to cause the robotic vehicle 2220 to perform the delivery of the item 305. Said data is depicted as being stored in the database 556. Said data is locally stored by the server 554 in this embodiment. In this embodiment, the database 556 comprises a plurality of order request data 610, each order request data 610 comprising information about a corresponding order. More specifically, a given order request data 610 comprise an order specific information 605 comprising information 612 about an order ID of a corresponding order and information 614 about an item to be delivered.

The order request data 610 also comprises user specific information 616 about an item provider and a user that placed the corresponding order to said item provider. The target QR code 612 is thus associated with said item provider and said user. As previously described, the order specific information 605 is the part of the order request data 610 that may be transmitted to the item provider. Said order specific information 605 may be transmitted by the server 554 via the communication network 552 based on the information 616 comprising, for example, coordinates of the item provider 562. It should also be noted that information about the user, that is a recipient of the corresponding delivery, are comprised in information 616 and are thus not transmitted to the item provider.

Upon receiving, from the selected robotic vehicle 220, the request for order confirmation comprising an in-use order ID, the server 554 determines whether the in-use order ID matches a target order ID of an order that has been transmitted to said item provider. In response to the in-use order ID matching the target order ID, the server 554 triggers the selected robotic vehicle 220 from the fleet 550 to receive the item to be delivered (e.g. item 305). To do so, the server 554 may for example transmit instructions causing the robotic vehicle 220 to open the lid 223, thereby giving access to the interior storage space 307 for placing the item to be delivered. The server 554 may further transmits that the destination information to the selected robotic vehicle 220. The server 554 then triggers operation of the selected robotic vehicle 220 to perform the delivery based on the transmitted destination information.

In some embodiments, in response to the in-use order ID matching the target order ID, the server 554 communicates with the selected robotic vehicle to retrieve a current location thereof. The server 554 further generate navigation information based on said current location and the destination information. As an example, the navigation information may be indicative of an itinerary to be followed by the selected robotic vehicle 220 to reach a destination provided as part of the destination information. The server 554 may further transmit the navigation information to the selected robotic vehicle 220. Operation of the selected robotic vehicle 220 for delivery items can then be triggered in accordance with the navigation information.

In some embodiments, the order request data 610 also comprises information about a target item weight. In other words, the target item weight is indicative of an expected weight of the item to be delivered. Said expected weight may be for example based on the information 614. Upon receiving the item in the interior storage space 307, the weighting device may transmit, via the computing device 210, data indicative of an in-use item weight to the server 554. In response to the in-use item weight matching the target item weight, the server 554 may cause the lid 223 to close and cause the robotic vehicle to proceed with the delivery. Alternatively, in response to the in-use item weight not matching the target item weight, the server 554 may cause the robotic vehicle 220 to emit a luminous and/or audio signal to the item provider to indicate an erroneous in-use item weight. As an example, such mismatch may be due to one of the items to be delivered being missing.

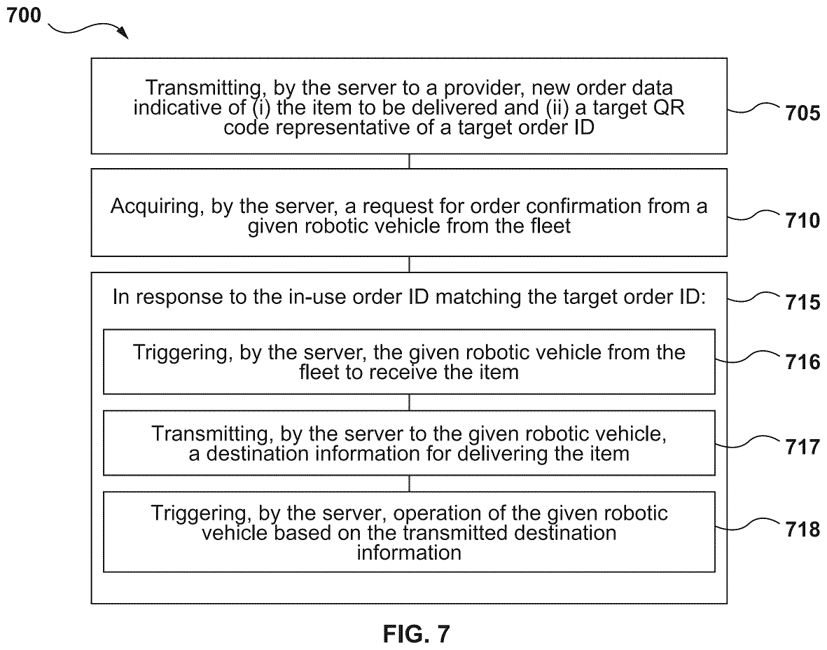

FIG. 7 is flow diagram of a method 700 for delivering an item to a user, such as the user 572A, according to some embodiments of the present technology. In one or more aspects, the method 700 or one or more steps thereof may be performed by a computing device, such as the computing device 210. The method 700 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The item is to be delivered by one of a fleet of robotic vehicles, such as the fleet 550 of the robotic vehicles 220, the fleet of robotic vehicles being communicatively coupled with a server, such as the server 554.

In this embodiment of the method 700, the robotic vehicle comprises a computer system, and a plurality of sensors communicably connected the computer system, the plurality of sensors comprising a camera sensor that may read a QR code, a wheel controller communicably connected the computer system, and a plurality of wheels operatively connected to the wheel controller. The robotic vehicle also comprises the support assembly 350 disposed on one or more wheels of the plurality of wheels, the one or more wheels being disposed on a frontside of the robotic vehicle, said frontside being defined by a direction of travel of the robotic vehicle.

### STEP 705: Transmit, by the Server to an Item Provider, New Order Data

At step 705, the server transmits a new order data to an item provider, such as item provider 562. The order data comprises information about the item to be delivered and a target QR code representative of a target order ID. As an example, the order data may have been generated by the server in response to the user placing an order at the item provider. For example, the user may place the order by using a corresponding user device (e.g. a smartphone, a person computer or any other suitable device) communicably connected to the server. Upon receiving the placed order, or “current order”, the server may generate the target QR code, thereby forming the order data, and transmit said order data to the item provider. In this embodiment, the server locally stores a destination information for delivering the item. For example, said destination information may comprise an address of the user and may have been provided by the user upon placing the current order or a previous order. The user may also have entered the destination information to the server at any time before placing the current order. In this embodiment, information about the user is locally stored by the server or by a database communicably connected to the server.

STEP 710: Acquire, by the Server, a Request for Order Confirmation from a Given Robotic Vehicle from the Fleet

At step 710, the servers acquire a request for order confirmation from a given robotic vehicle from the fleet. More specifically, once the item has been prepared by the item provider, the item provider may select any robotic vehicle of the fleet to perform the delivery to the user. For example, the item provider may select the nearest robotic vehicle, or the only robotic vehicle near the item provider. As such, it can be said that the present technology provides freedom to choose any robotic vehicle to the item provider. In other words, the item provider may select a robotic vehicle standing nearby, or any other robotic vehicle without pre-booking it on the server. In this embodiment, the item provider may select a given robotic vehicle by presenting an in-use QR code to a camera sensor of the robotic vehicle.

Upon reading the in-use QR code, the robotic vehicle extracts an in-use order ID and transmits said in-use order ID to the server under the form of a request for order confirmation. The server further determines whether the in-use order ID matches the target order ID that was transmitted to the item provider. In response to the in-use order ID not matching the target order ID, the server may cause the robotic vehicle to emit a luminous and/or audio signal to the item provider 562 to indicate an erroneous in-use QR code. In response to the in-use order ID matching the target order ID, the server performs the following sub-steps.

In some embodiments, step 720 may include selecting, by an operator of the item provider, the given robotic vehicle. More specifically, data exchanged between the server and the item provider may allow, in use, selection of any robotic vehicle by the operator of the item provider. For example and without limitation, the operator of the item provider may select a closest robotic vehicle 220 or a random one among the fleet 550.

SUB-STEP 716: Trigger the Given Robotic Vehicle from the Fleet to Receive the Item

At sub-step 716, the server triggers the selected robotic vehicle to receive the item. In this embodiment, the server transmits instructions to the robotic vehicle which, upon being executed by the computer system of the robotic vehicle, cause the lid to be actuated from a closed position to an opened position. In the opened position, the lid thus provides access to an interior storage space to place the item to be delivered. In the context of the resent disclosure, said item may be for example and without limitation, one or more edible items, drinkable items and/or non-consumable items. In some embodiments, the operator places the item in the interior storage space.

The server may further transmit instructions to the robotic vehicle which, upon being executed by the computer system, cause the lid to be actuated from the opened position to the closed position. Alternatively, the robotic vehicle may maintain the lid in the opened position for a pre-determined time duration. In an alternative embodiment, the robotic vehicle comprises a weighting device in the interior storage space communicably connected to the computer system. As such, the computer system may, in response to the weighting device measuring a weight above a pre-determined threshold, cause the lid to be actuated from the opened position to the closed position. In yet an alternative embodiment, the target order ID is associated with a target item weight, information about the target item weight being locally stored by the server. Upon the item provider placing the item in the interior storage space, the weighting device measures an in-use item weight. The robotic vehicle may further transmit the in-use item weight to the server. In response to the in-use item weight matching the target item weight, the server may cause the lid to close and cause the robotic vehicle to proceed with the delivery. Alternatively, in response to the in-use item weight not matching the target item weight, the server may cause the robotic vehicle to emit a luminous and/or audio signal to the item provider to indicate an erroneous in-use item weight. In the context of the present disclosure, the in-use item weight may be considered as matching the target item weight in response to the in-use item weight being in a weight range centered around at the target item weight. For example, said weight range may be 500 grams above or below the target item weight.

### SUB-STEP 717: Transmit, to the Given Robotic Vehicle, the Destination Information for Delivering the Item

At sub-step 717, once the robotic vehicle has received the item to be delivered, the server transmits the destination information to the selected robotic vehicle. The destination information may comprise, for example GPS coordinates readable by the computer system of the robotic vehicle or any other indication of a destination of the delivery under a computer-readable format.

In some embodiments, at sub-step 717, the server may communicate with the selected robotic vehicle to retrieve a current location thereof. Additionally or alternatively, a current location of the robotic vehicle may either be tracked by the server and/or provided by the computing device of the robotic vehicle in combination with a current order ID extracted from an in-use QR code. The server may further generate a navigation information based on said current location and the destination information. As an example, the navigation information may be indications of an itinerary to be followed by the selected robotic vehicle to reach a destination indicated in the destination information. The server may further transmit the navigation information to the selected robotic vehicle along with the destination information.

### SUB-STEP 718: Trigger Operation of the Given Robotic Vehicle Based on the Transmitted Destination Information

At sub-step 718, the server triggers operation of the selected robotic vehicle to navigate based on the transmitted destination information. In this embodiment, the robotic vehicle navigates with the lid in the closed position to prevent the item from being damaged during navigation. The server may receive indication of a current position of the robotic vehicle during navigation. Upon the robotic vehicle reaching a destination of the delivery indicated in the destination information, the server may cause the lid to be actuated from the closed position to the opened position.

As an example, the server may trigger operation of the robotic vehicle based on the destination information and/or the navigation information.

In this embodiment, the server provides the target QR code to the user device. The user device may present a second in-use QR code indicative of a second in-use order ID to the camera sensor of the robotic vehicle. The robotic vehicle may transmit the second in-use order ID to the server. In response to the second in-use order ID matching the target order ID, the server triggers the robotic vehicle to enable the user to collect the item. As an example, upon determining that the second in-use order ID matches the target order ID, the server may cause the lid to be actuated from the closed position to the opened position so the user may collect the item.

Generally, the method of opening the lid of the robotic vehicle is not specifically restricted. In another embodiment, they may use a user device for entering personal information of a user for automatically opening the lid. Additionally or alternatively, a special app may be used for pushing an opening button to initiate the lid opening.

It should be expressly understood that not all technical effects mentioned herein need to be enjoyed in each and every implementation of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of delivering an item to a user, the item to be delivered by one of a fleet of robotic vehicles, the fleet of robotic vehicles being communicatively coupled with a server, the method comprising:
transmitting, by the server to an item provider, new order data indicative of (i) the item to be delivered and (ii) a target QR code representative of a target order ID,
the server locally storing destination information for delivering the item;
acquiring, by the server, a request for order confirmation from a given robotic vehicle from the fleet,
the request for order confirmation comprising an in-use order ID having been extracted by the given robotic vehicle from an in-use QR code presented to a camera sensor of the given robotic vehicle;
in response to the in-use order ID matching the target order ID:
triggering, by the server, the given robotic vehicle from the fleet to receive the item;
transmitting, by the server to the given robotic vehicle, the destination information for delivering the item; and
triggering, by the server, operation of the given robotic vehicle based on the transmitted destination information.

2. The method of claim 1, wherein the item is selected from a group of items, said group comprising: edible items, drinkable items and non-consumable items.

3. The method of claim 1, further comprising, prior to transmitting the new order data, receiving, by the server and from a user device associated with the user, information about the item to be delivered.

4. The method of claim 3, further comprising, upon receiving information about the item to be delivered, generating a target QR code based on information associated with the user.

5. The method of claim 4, wherein the server is communicably connected to a database, the database being configured to store said information about the user.

6. The method of claim 5, wherein said information about the user comprises the destination information associated with the user for delivering the item.

7. The method of claim 1, wherein the robotic vehicle comprises a lid operable between an opened position and a closed position, and triggering, by the server, the given robotic vehicle from the fleet to receive the item comprises:
causing, by the server, the lid to be actuated from the closed position to the opened position.

8. The method of claim 7, wherein triggering, by the server, the given robotic vehicle from the fleet to receive the item further comprises:
causing, by the server, the lid to be actuated from the opened position to the closed position once the item has been received by the robotic vehicle.

9. The method of claim 8, wherein the target order ID is associated with a target item weight, information about the target weight being locally stored by the server, and causing the lid to be actuated from the opened position to the closed position once the item has been received by the robotic vehicle is made in response to:
receiving, by the server, an in-use item weight, measured by the robotic vehicle, of the item received by the robotic vehicle; and
determining, by the server, that the in-use item weight is in a pre-determined range weight centered at target item weight.

10. The method of claim 1, further comprising, in response to the in-use order ID matching the target order ID, generating, by the server, a navigation information based on a current location of the given robotic vehicle and the destination information, the navigation information comprising indications of an itinerary to be followed by the robotic vehicle.

11. The method of claim 10, further comprising transmitting, by the server to the given robotic vehicle, the navigation information.

12. The method of claim 11, wherein triggering, by the server, operation of the given robotic vehicle based on the transmitted destination information comprises:
triggering operation of the given robotic vehicle based on indications comprised in the navigation information.

13. A robotic vehicle for delivering an item from an item provider to a user, the robotic vehicle being communicably coupled to a server, the robotic vehicle comprising:
a body defining an interior space;
a lid operable to access the interior space;
a camera sensor disposed on an external side of the body; and
a processor configured to control operation of the robotic vehicle, the processor being configured to:
transmit, to the server, a request for order confirmation, the request for order confirmation comprising an in-use order ID having been extracted by the robotic vehicle from an in-use QR code presented to the camera sensor;
receive, from the server and in response to the in-use order ID matching a target order ID, instructions which, upon being executed by the processor, cause the lid to open such that the interior space receives the item;
receive, from the server, a destination information for delivering the item; and
cause the robotic vehicle to navigate based on the destination information.

14. The robotic vehicle of claim 10, wherein the lid is operable between an opened position and a closed position.

15. The robotic vehicle of claim 11, wherein the processor is further configured to:
cause the lid to be actuated from the opened position to the closed position once the item has been received in the interior storage space.

16. The robotic vehicle of claim 12, further comprising a weighting device communicably connected to the processor and configured to determine an in-use item weight of the item received in the interior space storage.

17. The robotic vehicle of claim 13, wherein the processor is further configured to:
transmit information received from the weighting device to the server; and
in response to the server determining that the in-use item weight is in a weight range centered at a target item weight:
receive, from the server, instructions which upon being executed by the processor cause the lid to close.
